(19) United States
(12) Patent Application Publication
(10) Pub. No.: US 2012/0201034 A1
(43) Pub. Date: Aug. 9, 2012

(54) Wide-Range Reflective Structure

(76) Inventor: CHIA-MAO LI, Taipei City (TW)

(21) Appl. No.: 13/451,529

(22) Filed: Apr. 19, 2012

Related U.S. Application Data
(63) Continuation-in-part of application No. 12/566,686, filed on Sep. 25, 2009.

(51) Int. Cl. F21V 13/02; F21V 7/20

(52) U.S. Cl. 362/345

(57) ABSTRACT

A wide-range reflective structure comprises a reflective case, a heat-sink metal frame, a heat conductive plate, and one control member for directing light beams. The heat conductive plate defines a recess for holding the heat-sink metal frame. The reflective case has a first inner curved reflective surface, a second inner curved reflective surface, a third inner curved reflective surface, and a fourth inner curved reflective surface. The reflective case is attached to the heat conductive plate, enclosing the heat-sink metal frame. The control member has two concave reflective surfaces. The first inner curved reflective surface has an inclination angle greater than the second inner curved reflective surface. The third inner curved surface has an inclination angle approximately equal to the fourth inner curved surface. As such, the inner curved reflective surfaces can cooperate with the control member to direct light beams from LEDs to a target more extensively and uniformly.

### CROSS-REFERENCE TO RELATED APPLICATION

This application is a continuation-in-part of the co-pending patent application Ser. No. 12/566,686, owned by the same applicant.

### TECHNICAL FIELD OF THE INVENTION

The present invention relates to a wide-range reflective structure and, more particularly to a reflective structure which has inner curved reflective surfaces being cooperated with a control member thereof for directing light beam emitted from LEDs to a target more extensively and uniformly.

### DESCRIPTION OF THE PRIOR ART

LED lamps are gradually applied to various working sites. For improving the efficacy of the light beam from LEDs, various lighting devices provide internal structure designs to extend the angles of the light beams output from the lighting devices, as can be seen in U.S. patent, application Ser. No. 11/808,871. Regarding the disclosed lighting device, as shown in FIGS. 1 and 2, since the light beams emitted from LEDs 23a, 23b, 23c and 23d are reflected by the reflection surfaces 2511, 2512, the light beams can be output more uniformly. This mitigates the problem of some conventional lighting devices in that the central portion of the illuminating area by the projecting light beams is significantly higher than the lateral portions thereof However, in the disclosed lighting device, due to the inner surfaces of the light box shell 21 is vertical, the light beams emitted from 23a, 23b, 23c and 23d cannot create an extensive or wide-range pattern of illumination, especially when it is applied to street lighting, so that the illuminating area for a target would be limited or the illuminating area for a target cannot be extended to a desired coverage. Besides, the use of the reflection surfaces 2511, 2512 of the reflection element 251 to increase the illuminating range is achieved only by diffusion; therefore the illuminating effect is limited. Thus, there is a room for further improvement.

### SUMMARY OF THE INVENTION

The primary object of the present invention is to provide a wide-range reflective structure that employs inner curved reflective surfaces thereof to extend the illuminating range for a target.

To achieve the above object, the wide-range reflective structure may comprise a reflective case with appropriate optical characteristics for LEDs, a heat-sink metal frame, a heat conductive plate, and at least one control member for directing light beams. The heat conductive plate defines a recess for holding the heat-sink metal frame. The heat-sink metal frame is provided with light guiding surfaces, each with appropriate optical characteristics for LEDs, for changing the light output angle of LEDs so as to enhance the optical efficiency. The heat-sink metal frame is good for conducting heat. Due to a large contact surface between the heat-sink frame and the heat conductive plate, a large amount of heat generated from the light source of LEDs can be quickly absorbed and transferred to the heat conductive plate, so that the heat generated from the light source of LEDs can be quickly dissipated, thereby lowering the temperature significantly. The reflective case has a first inner curved reflective surface, a second inner curved reflective surface, a third inner curved reflective surface, and a fourth inner curved reflective surface. The first inner curved reflective surface is located opposite to the second inner curved surface. The third inner curved reflective surface is located opposite to the fourth inner curved surface. The inner curved reflective surfaces defines an inner space of the reflective case, the inner space including a top opening at a top of the reflective case and a bottom opening at a bottom of the reflective case. The reflective case is attached to the heat conductive plate. The bottom of the reflective case encloses the heat-sink metal frame held in the slot of the heat conductive plate. The control member is provided in the reflective case near to the top of the reflective case. The control member has two concave reflective surfaces respectively corresponding to the third and fourth inner curved surfaces. The first inner curved reflective surface has an inclination angle greater than the second inner curved reflective surface. The first inner curved reflective surface allows the light beams incident thereon to be reflected to cover a wide range in one dimension, while the second inner curved reflective surface allows the light beams incident thereon to be reflected to cover a less range as compared with that of the first inner curved reflective surface. The third inner curved surface is located symmetrically with the fourth inner curved surface and has an inclination angle approximately equal to the fourth inner curved surface. The inner curved reflective surfaces can cooperate with the control member to direct light beams from LEDs, which are disposed on the heat-sink metal frame, at an angle to a target and create a wide, intensive, and uniform illuminating area for the target. Accordingly, the present invention can achieve a design of high light efficiency and low power consumption.

Other objects, advantages, and novel features of the present invention will become more apparent from the following detailed description when taken in conjunction with the accompanying drawings.

### BRIEF DESCRIPTION OF THE DRAWINGS

FIG. 1 shows an internal structure of a conventional lighting device.

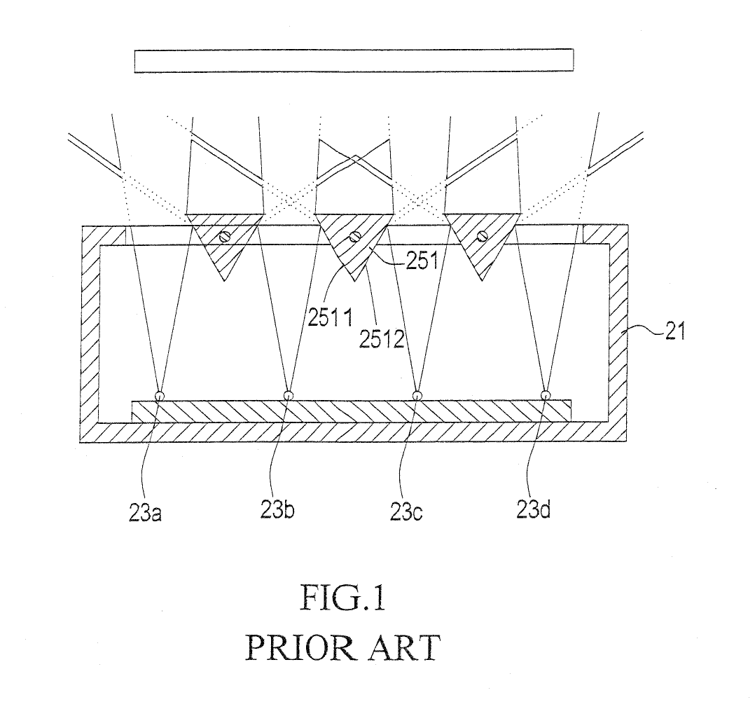

FIG. 2 shows a schematically illuminating view of the conventional lighting device.

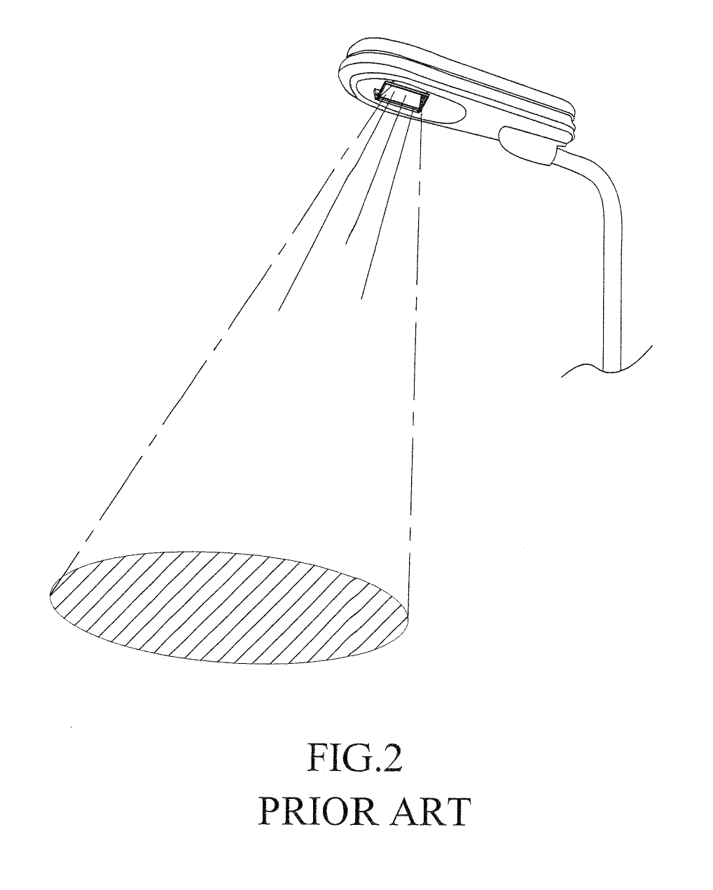

FIG. 3 shows a 3-dimesional view of the present invention.

FIG. 4 shows an exploded view of the present invention.

FIG. 5 shows a cross-sectional view of the present invention.

FIG. 6 shows a partially cutting view of the present invention.

FIG. 7 shows another cross-sectional view of the present invention.

FIG. 8 shows a schematic view of the present invention, wherein the light beams emitted from LEDs pass by the control member.

FIG. 9 shows another schematic view of the present invention, wherein the light beams emitted from LEDs are reflected by the control member.

FIG. 10 shows a further schematic view of the present invention, wherein some of the light beams emitted from LEDs pass by the control member while some of the light beams emitted from LEDs are reflected by the control member.

FIG. 11 shows a lighting characteristic curve of the present invention.

FIG. 12 shows a schematic view of the present invention being applied to a street lamp.

FIG. 13 shows another schematic view of the present invention being applied to a street lamp.

### DETAILED DESCRIPTION OF THE PREFERRED EMBODIMENTS

To allow the contents and the effectiveness of the present invention to be understood easily, a preferred embodiment with reference to the accompanying drawings is detailed below.

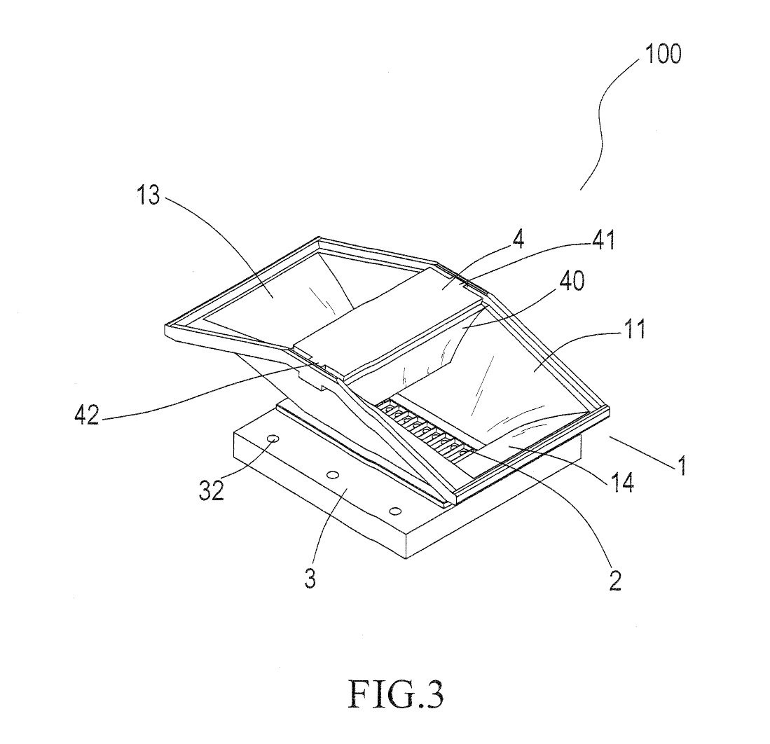

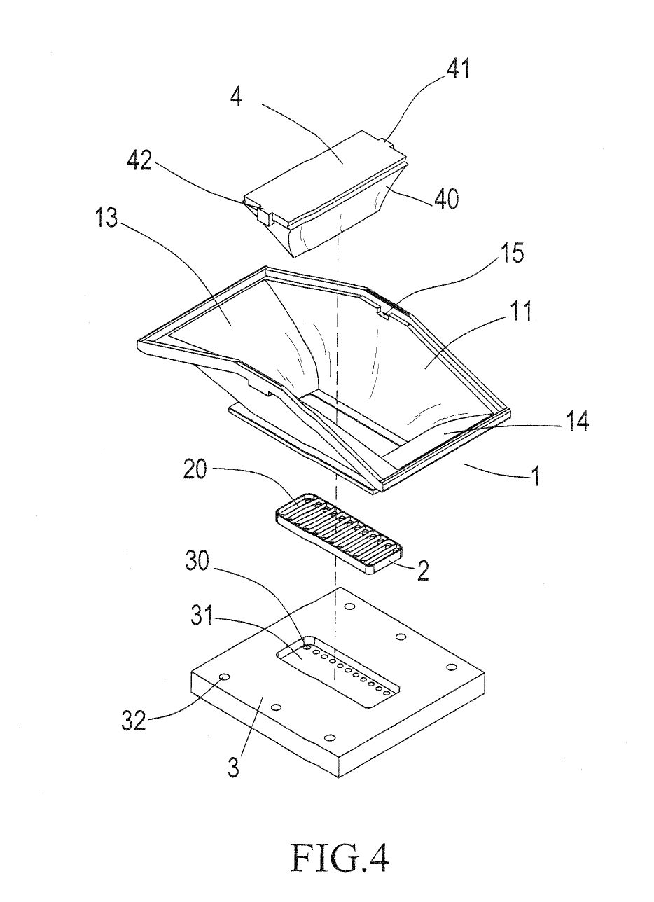

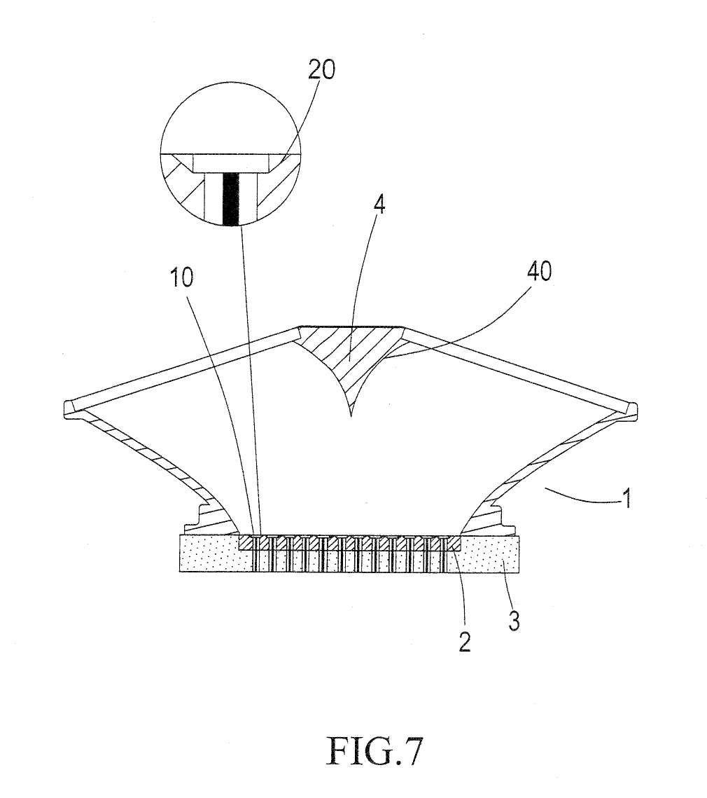

Referring to FIGS. 3 and 4, a wide-range reflective structure according to the present invention is shown, which comprises reflective case 1, a heat-sink metal frame 2, a heat conductive plate 3, and at least one control member 4 for directing light beams. The heat conductive plate 3 defines a recess 31 for holding the heat-sink metal frame 2 and a plurality of through holes 32 for being inserted with screws for fixing the plate onto a lamp structure (not shown). Also, a plurality of LED holes 30 is formed on a bottom surface which defines the recess 31 of the heat conductive plate 3, for accommodating LEDs 10 (see FIG. 7). The heat-sink metal frame 2 is provided with light guiding surfaces 20, each with appropriate optical characteristics for LEDs, for changing the light output angle of LEDs so as to enhance the optical efficiency. Furthermore, the heat-sink metal frame 2 is good for conducting heat. Due to a large contact surface between the heat-sink frame 2 and the heat conductive plate 3, a large amount of heat generated from the light source of LEDs can be quickly absorbed and transferred to the heat conductive plate 3, so that the heat generated from the light source of LEDs can be quickly dissipated, thereby lowering the temperature significantly. Around the outer periphery of the heat-sink metal frame 2 is attached with the reflective case 1, which has appropriate optical characteristics for LEDs. As shown, the reflective case 1 is a hollow case, which is provided with inner curved reflective surfaces, which defines an inner space therein, including a top opening and a bottom opening. The reflective case 1 is attached to the heat conductive plate 3. The bottom of the reflective case 1 encloses the heat-sink metal frame 2. The control member 4, which has concave reflective surfaces 40, is provided in the reflective case 1 near to the top thereof. The control member 4 further has fixing protrusions 41, 42 for engaging with slots 15 defined on two opposite sides of the reflective case 1, to allow the control member 4 to be fixed onto the reflective case 1.

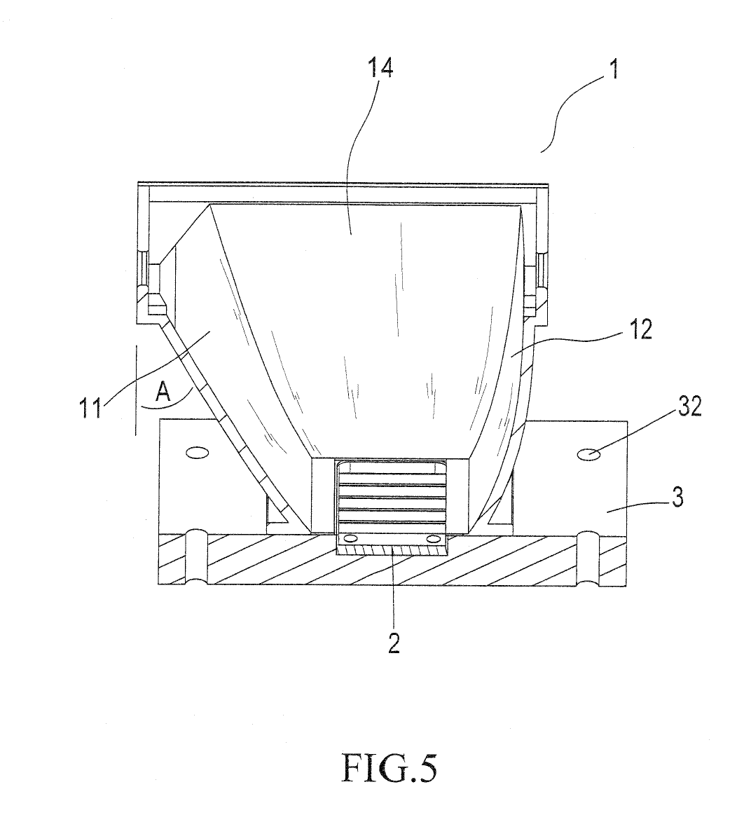

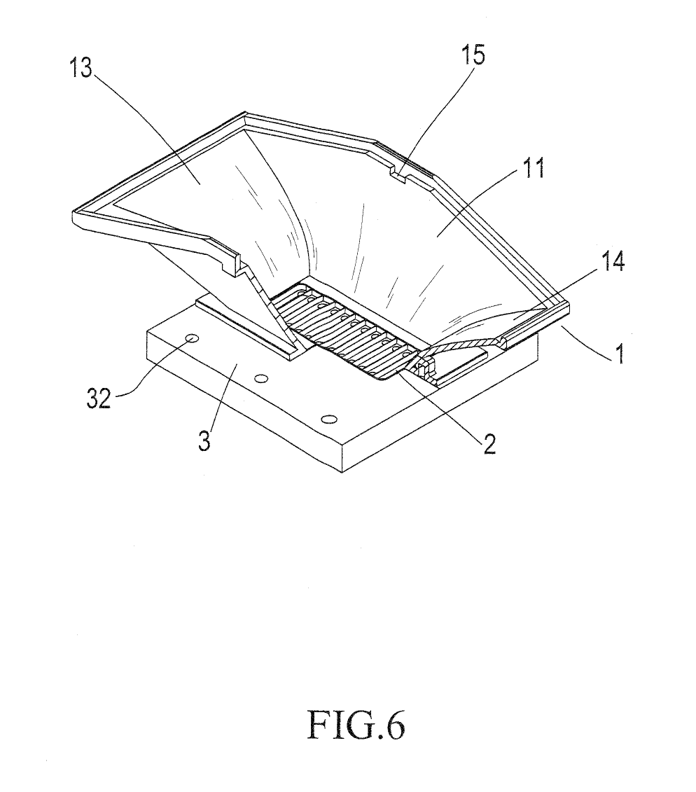

Turning now to FIGS. 5 and 6, the interior of the reflective case 1 is provided with curved reflective surfaces, including a first inner curved reflective surface 11, a second inner curved reflective surface 12, a third inner curved reflective surface 13, and a fourth inner curved reflective surface 14; wherein the first inner curved reflective surface 11 is located opposite to the second inner curved surface 12, the third inner curved reflective surface 13 is located opposite to the fourth inner curved surface 14; the control member 4 has two concave reflective surfaces 40 respectively corresponding to the third and fourth inner curved surfaces 13, 14; the first inner curved reflective surface 11 has an inclination angle greater than the second inner curved reflective surface 12 (the inclination angle is the angle between a surface and a vertical line, as indicated by the symbol A for the first inner curved reflective surface 11), whereby the first inner curved reflective surface 11 allows the light beams incident thereon to be reflected to cover a wide range in one dimension, while the second inner curved reflective surface 12 allows the light beams incident thereon to be reflected to cover a less range as compared with that of the first inner curved reflective surface 11; the third inner curved surface 13 is located symmetrically with the fourth inner curved surface 14 and has an inclination angle approximately equal to the fourth inner curved surface 14, whereby the third and fourth inner curved reflective surfaces 13, 14 allows the light beams incident thereon to be reflected to cover a wide range in another dimension.

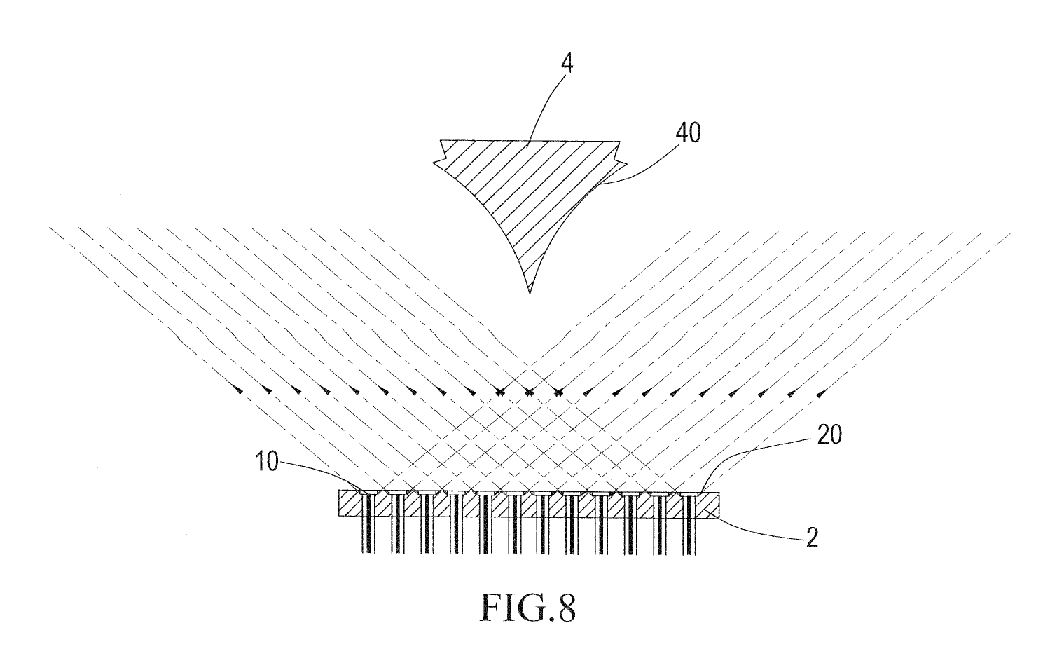

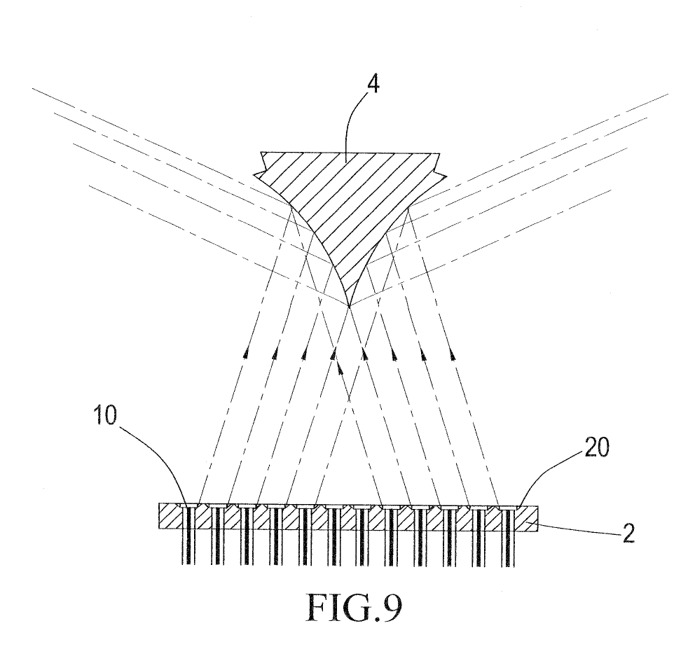

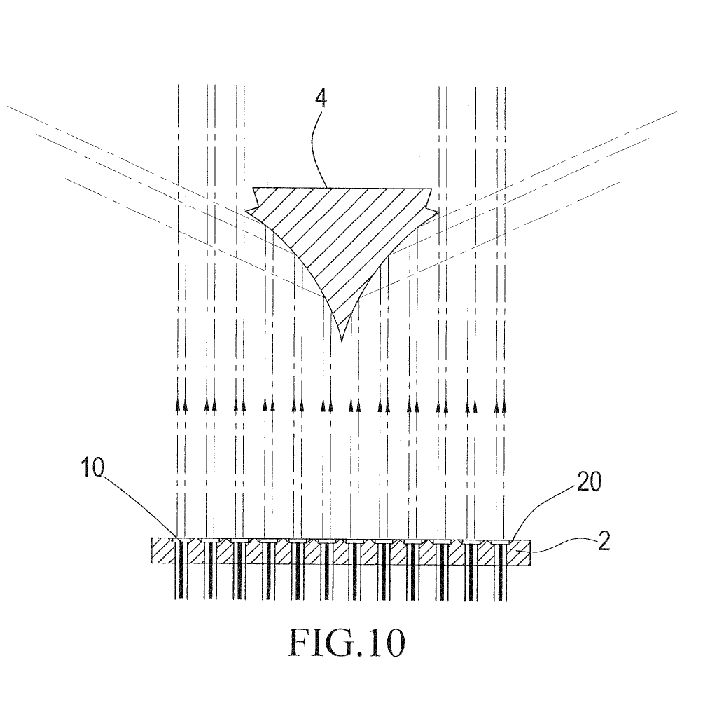

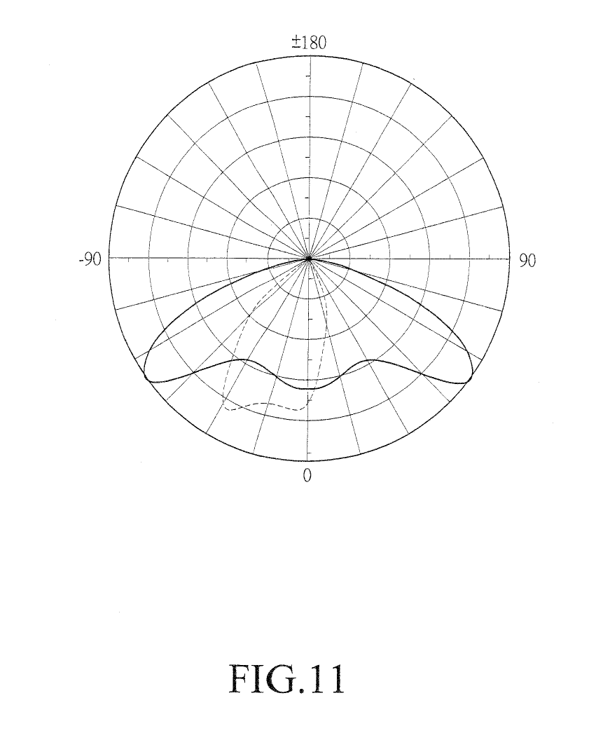

As shown in FIGS. 7-11, since a flat-surface LED generally emits light perpendicular to its surface, the control member 4 of the present invention is preferably located at a center of the top opening. The inner curved reflective surfaces can cooperate with the control member 4 to direct light beams from LEDs, which is disposed on the heat-sink metal frame 2, at an angle to a target and create a wide, intensive, and uniform illuminating area for the target. The reflective structure of the present invention provides an illumination through applying the feature of wing-shaped lighting curve, as shown in FIG. 11. The illumination is not only achieved by light diffusion. Thus, the illuminating range will become wider than conventional lighting devices, thereby causing the present invention to be more suitable for street lighting.

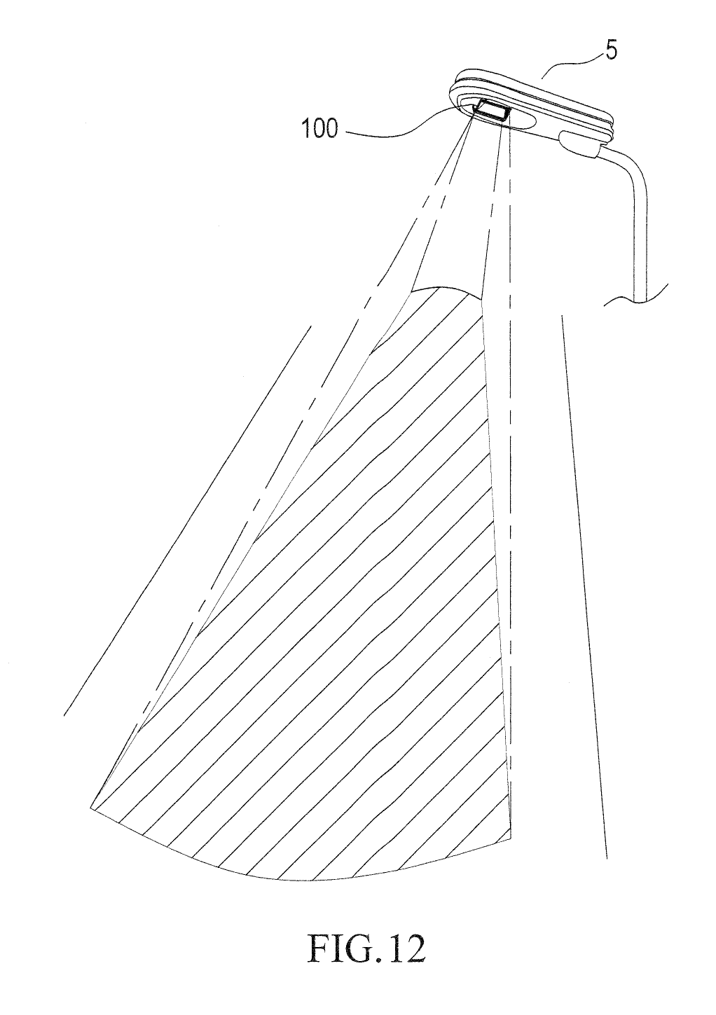

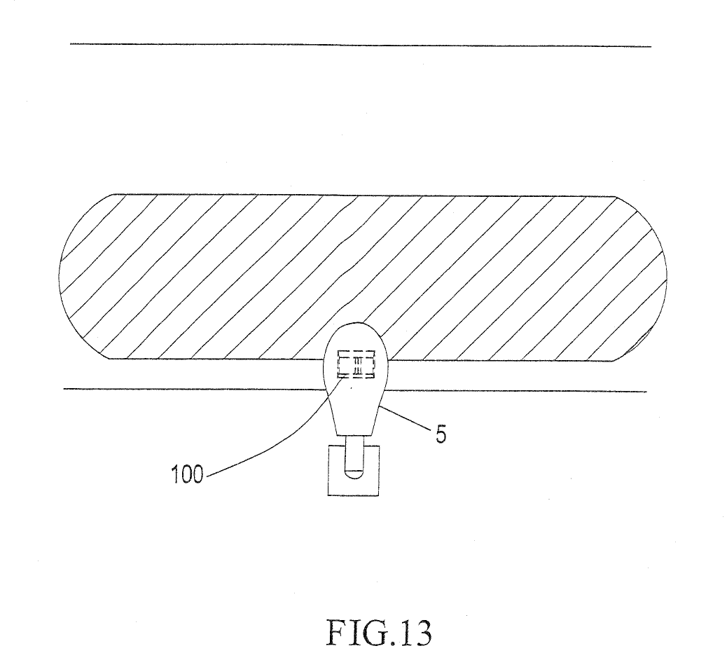

When the present invention is applied to street lighting, as shown in FIGS. 12 and 13, the street lamp 5 employing the reflective structure of the present invention can be aimed at one section of a road surface, which is at an angle to the street lamp 5. Since the reflective structure of the present invention can direct light beam to cover the section of the road surface intensively and uniformly without casting light beams onto other unnecessary objects, it can help reducing light pollution, increasing the span between light poles, reducing the quantities of the street lamps, and improving traffic safety.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A wide-range reflective structure, which comprises a reflective case with optical characteristics for LEDs, a heat-sink metal frame, a heat conductive plate, and at least one control member for directing light beams, said heat conductive plate defining a recess for holding said heat-sink metal frame, said reflective case having a first inner curved reflective surface, a second inner curved reflective surface, a third inner curved reflective surface, and a fourth inner curved reflective surface, said first inner curved reflective surface being located opposite to said second inner curved surface, said third inner curved reflective surface being located opposite to said fourth inner curved surface, said inner curved reflective surfaces defining an inner space of said reflective case, said inner space including a top opening at a top of said reflective case and a bottom opening at a bottom of said reflective case, said reflective case being attached to said heat conductive plate, the bottom of said reflective case enclosing said heat-sink metal frame held in said slot of said heat conductive plate, said control member being provided in said reflective case, said control member having two concave reflective surfaces respectively corresponding to said third and fourth inner curved surfaces, said first inner curved reflective surface having an inclination angle greater than said second inner curved reflective surface, said first inner curved reflective surface allowing the light beams incident thereon to be reflected to cover a wide range in one dimension, while said second inner curved reflective surface allowing the light beams incident thereon to be reflected to cover a less range as compared with that of said first inner curved reflective surface, said third inner curved surface being located symmetrically with said fourth inner curved surface and having an inclination angle approximately equal to said fourth inner curved surface; whereby said inner curved reflective surfaces can cooperate with said control member to direct light beams from LEDs, which are disposed on said heat-sink metal frame, at an angle to a target and create a wide, intensive, and uniform illuminating area for the target.

2. The wide-range reflective structure of claim 1, wherein said heat-sink metal frame is provided with light-guiding surfaces each with optical characteristics for LEDs.

3. The wide-range reflective structure of claim 1, wherein two opposite sides of said reflective case each defines a slot to allow said control member to be fixed onto said reflective case

4. The wide-range reflective structure of claim 1, wherein said control member is provided with at least one fixing protrusion for fixing said control member onto said reflective case.

5. The wide-range reflective structure of claim 1, which is applied to street lighting.
